(19) United States
(12) Patent Application Publication
(10) Pub. No.: US 2018/0030833 A1
(43) Pub. Date: Feb. 1, 2018

(54) GAS COMPRESSOR

(71) Applicant: CALSONIC KANSEI CORPORATION, Saitama-shi, Saitama (JP)

(72) Inventor: Toshikatsu MIYAJI, Saitama-shi, Saitama (JP)

(73) Assignee: CALSONIC KANSEI CORPORATION, Saitama-shi, Saitama (JP)

(21) Appl. No.: 15/550,419

(22) PCT Filed: Jan. 19, 2016
(86) PCT No.: PCT/JP2016/051401

§ 371 Date: Aug. 11, 2017

(30) Foreign Application Priority Data
Feb. 12, 2015 (JP) 2015-025286

(51) Int. Cl. F01C 21/08; F04C 18/02; B60H 1/32; F04C 18/344

(52) U.S. Cl. CPC F01C 21/0863; F04C 18/3442; F04C 18/0207; B60H 1/3223; F04C 28/16

(57) ABSTRACT

A gas compressor is configured such that a suction-side area that is in sliding contact with the inner circumferential surface of a cylinder chamber when a compression chamber is in the suction stroke has a larger radius of curvature than that of a compression-side area that is in sliding contact with the inner circumferential surface of the cylinder chamber when the compression chamber is in the compression stroke.

### TECHNICAL FIELD

The present invention relates to what is called a rotary vane gas compressor.

### BACKGROUND ART

There has been known a rotary vane gas compressor used for a vehicle air conditioner and the like. A rotary vane gas compressor has a cylinder block having a cylinder chamber, a rotor rotatably arranged inside the cylinder chamber, and multiple vanes housed in respective vane slots. The vane slots are formed to extend from multiple positions arranged on the circumferential surface of the rotor with intervals in the rotational direction of the rotor, in directions inclined with respect to the radial direction of the rotor.

Each vane is biased in the direction of protruding from the vane slot by high-pressure refrigerant introduced into the back space of the vane in the vane slot, a coil spring housed in the back space of the vane, or the like, and the distal end surface of the vane slides on the inner circumferential surface of the cylinder chamber during the rotation of the rotor.

There is a space between the outer circumferential surface of the rotor and the inner circumferential surface of the cylinder chamber. This space is created by forming the cylinder chamber to be an ellipse or the like other than a precise circle, or by offsetting the rotational center of the rotor from the center of the cylinder chamber. A closed compression chamber is formed inside each section of this space separated by two adjacent vanes.

As the distance between the outer circumferential surface of the rotor and the inner circumferential surface of the cylinder chamber decreases along with the rotation of the rotor, the vanes retract into the vane slots and the volume of the compression chamber decreases. As a result, the refrigerant in the compression chamber is compressed, and then the compressed refrigerant is discharged from the cylinder chamber to the outside of the compressor (see Patent Literatures 1 and 2).

In a rotary vane gas compressor, the contact angle of the vane with respect to the inner circumferential surface of the cylinder chamber changes along with the rotation of the rotor. For this reason, the distal end surface of the vane is rounded with a larger curvature than the maximum curvature of the inner circumferential surface of the cylinder chamber so that the distal end surface of the vane slides smoothly on the inner circumferential surface of the cylinder chamber (see Patent Literature 3).

### CITATION LIST

### Patent Literature

Patent Literature 1: Japanese Patent Application Publication No. 2013-194549

Patent Literature 2: Japanese Patent Application Publication No. 2009-209702

Patent Literature 3: Japanese Patent Application Publication No. 2002-39084

### SUMMARY OF INVENTION

### Technical Problem

In order to bias the vane in the direction of protruding from the vane slot with the refrigerant pressure of high pressure refrigerant, the elastic force of a coil spring, or the like during the rotation of the rotor as described above, it is necessary to bias the vane from the back side such that the biasing force overcomes the counter force in the direction of retracting into the vane slot exerted by the refrigerant in the compression chamber on the distal end surface of the vane, even when the refrigerant in the compression chamber is compressed and the pressure thereof becomes high.

Accordingly, when the counter force exerted by the refrigerant in the compression chamber on the distal end surface of the vane is small in the suction stroke of the compression chamber, the biasing force from the back side of the vane is excessive. As a result, in the suction stroke of the compression chamber, the surface pressure of the distal end surface of the vane is high, increasing the sliding resistance of the vane on the inner circumferential surface of the cylinder chamber, so that a high torque is required to rotate the rotor.

An object of the present invention is to provide a rotary vane gas compressor in which the sliding resistance of the distal end surface of the vane on the inner circumferential surface of the cylinder chamber can be suppressed at a low level by reducing the surface pressure of the distal end surface of the vane sliding on the inner circumferential surface of the cylinder chamber, in particular, in the suction stroke.

### Solution to Problem

An aspect of the present invention is a gas compressor including:
a cylinder block in a cylindrical shape, having a cylinder chamber for compressing refrigerant;
a rotor rotatably provided in the cylinder chamber, the rotor having an outer circumferential surface facing an inner circumferential surface of the cylinder chamber and a plurality of vane slots opening on the outer circumferential surface with intervals in a rotational direction of the rotor; and
a plurality of vanes, each housed in each of the vane slots, the vane being biased in a direction of protruding from the outer circumferential surface, a distal end surface of the vane sliding on the inner circumferential surface along with rotation of the rotor, the vanes partitioning a space between the outer circumferential surface and the inner circumferential surface into a plurality of compression chambers in which the refrigerant is sucked and compressed, in which
the distal end surface of the vane has a suction-side area that is in sliding contact with the inner circumferential surface when the compression chamber separated by the vanes having the distal end surfaces is in a suction stroke, and a compression-side area that is in sliding contact with the inner circumferential surface when the compression chamber separated by the vanes having the distal end surfaces is in a compression stroke,
the suction-side area and the compression-side area have smaller radii of curvature than that of the inner circumferential surface, and
the suction-side area has a larger radius of curvature than that of the compression-side area.

According to this gas compressor, the suction-side area that is in sliding contact with the inner circumferential surface of the cylinder chamber when the compression chamber is in the suction stroke has a larger radius of curvature than that of the compression-side area that is in sliding contact with the inner circumferential surface of the cylinder chamber when the compression chamber is in the compression stroke. Accordingly, the surface pressure (which is obtained by Hertz contact stress) of the distal end surface of the vane when the distal end surface of the vane slides on the inner circumferential surface of the cylinder chamber is relatively smaller in the suction-side area having a large radius of curvature than in the compression-side area having a small radius of curvature. Thus, the actual friction coefficient when the suction-side area in the distal end surface of the vane slides on the inner circumferential surface of the cylinder chamber is smaller than the actual friction coefficient when the compression-side area slides.

Therefore, when the compression chamber is in the suction stroke where the counter force in the direction of retracting into the vane slot exerted by the refrigerant in the compression chamber on the distal end surface of the vane is smaller than when the compression chamber is in the compression stroke, even though the vane is biased in the direction of protruding from the vane slot by the same magnitude as when the compression chamber is in the compression stroke, the sliding resistance of the distal end surface of the vane on the inner circumferential surface of the cylinder chamber can be suppressed at a low level.

The compression-side area may have a single radius of curvature.

Of the distal end surface, an upstream portion in the rotational direction of the rotor may be included in the suction-side area, and a downstream portion may be included in the compression-side area.

A center of curvature of the suction-side area and a center of curvature of the compression-side area may be arranged on a normal line to the distal end surface at a connection point between the suction-side area and the compression-side area.

The connection point between the suction-side area and the compression-side area may be arranged downstream of a middle point of the distal end surface in the rotational direction.

### BRIEF DESCRIPTION OF DRAWINGS

FIG. 1 is a cross-sectional view illustrating an overall structure of a rotary vane gas compressor according to an embodiment of the present invention.

FIG. 2 is a cross-sectional view of the gas compressor in FIG. 1, taken along line A-A.

FIG. 3 is an enlarged view of a distal end portion of a vane viewed in the axial direction of a rotor when the distal end surface of the vane is formed as a circular arc surface having a single radius of curvature.

FIG. 4 is a graph illustrating a change in the surface pressure of the distal end surface of the vane when the distal end surface of the vane in FIG. 3 is in sliding contact with the inner circumferential surface of a cylinder chamber.

FIG. 5 is an enlarged view of a distal end portion of a vane viewed in the axial direction of the rotor when the distal end surface of the vane is formed by connecting two circular arc surfaces having different radii of curvature.

FIG. 6 is a graph illustrating a change in the surface pressure of the distal end surface of the vane when the distal end surface of the vane in FIG. 5 is in sliding contact with the inner circumferential surface of the cylinder chamber.

### DESCRIPTION OF EMBODIMENTS

Hereinafter, descriptions will be provided for a gas compressor according to an embodiment of the present invention with reference to the drawings. Note that the same or similar constituents are denoted by the same or similar reference signs, and descriptions therefor are omitted.

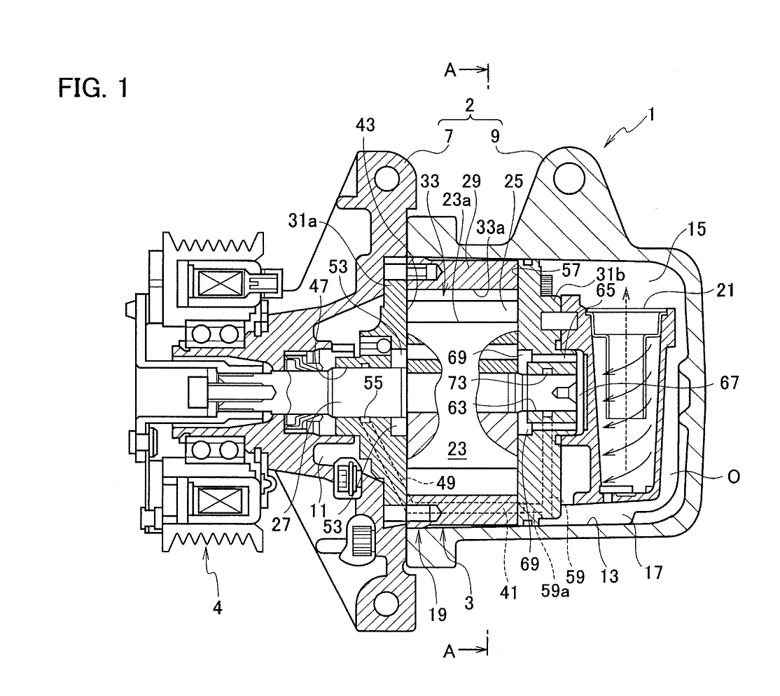

As illustrated in FIG. 1, a gas compressor 1 according to an embodiment of the present invention includes a substantially cylindrical housing 2, a compression portion 3 housed in the housing 2, a motor portion 4 that transmits a driving force to the compression portion 3.

The housing 2 includes a front head 7 in which a non-illustrated suction port is formed and a rear case 9 in a bottomed cylindrical shape. The opening of the rear case 9 is closed by the front head 7.

A compression portion 3 is attached to an inner wall 13 of the rear case 9. The compression portion 3 partitions the inside of the housing 2 to form a suction chamber 11 on one side and a discharge chamber 15 on the other side. On the outer circumference of the rear case 9, an unillustrated discharge port is formed to connect the discharge chamber 15 to a refrigeration cycle. Formed at a lower portion of the discharge chamber 15 is an oil reservoir 17. The oil reservoir 17 reserves oil O to keep the lubricity of the compression portion 3.

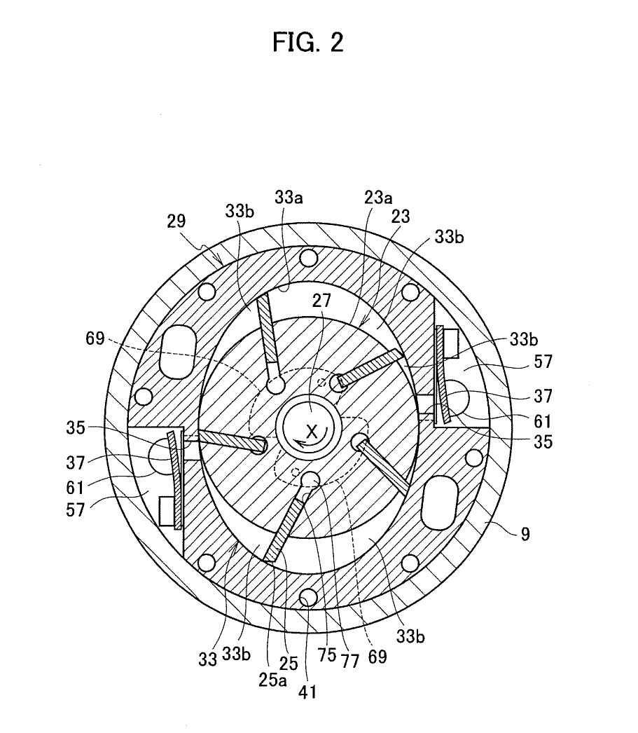

The compression portion 3 includes a compression block 19 forming a cylinder chamber 33, an oil separator 21 attached to the compression block 19, a rotor 23 rotatably housed in the cylinder chamber 33, vanes 25 (see FIG. 2) that protrudes from and retracts into the rotor 23 to partition the cylinder chamber 33, and a drive shaft 27 which is integrally fixed to the rotor 23 and transmits a driving force.

The compression block 19 includes a cylinder block 29, a pair of side blocks 31a and 31b, and the cylinder chamber 33 formed in the inner circumference of the cylinder block 29.

As illustrated in FIG. 2, the cylinder block 29 has the cylinder chamber 33 therein. The cylinder chamber 33 has an elliptical shape in a cross section perpendicular to the axial direction. As illustrated in FIG. 1, the openings of the cylinder chamber 33 are closed with both sides of the cylinder block 29 sandwiched by the pair of the side blocks 31a and 31b.

As illustrated in FIG. 2, the rotor 23 is arranged to be in contact with an inner circumferential surface 33a of the cylinder chamber 33 at two points thereof point-symmetric with respect to the rotation center. The rotor 23 includes multiple vane slots 75 which are open on an outer circumferential surface 23a of the rotor 23 and from and into which the vanes 25 are housed so as to be capable of protruding and retracting, and back-pressure spaces 77, each located on the back side (drive shaft 27 side) of the vane 25 in the vane slot 75.

The cylinder chamber 33 is partitioned into multiple sections in the rotational direction X of the rotor 23 in such a way that the distal end surfaces 25a of the vanes 25 which protrudes from and retracts into the vane slots 75 are in sliding contact with the inner circumferential surface 33a of the cylinder chamber during the rotation of the rotor 23. This forms multiple compression chambers 33b between the inner circumferential surface 33a of the cylinder chamber 33 and the outer circumferential surface 23a facing the inner circumferential surface 33a, of the rotor 23.

As the rotor 23 rotates, the volume of each compression chamber 33b increases or decreases in accordance with the elliptical shape of the inner circumferential surface 33a of the cylinder chamber 33. More specifically, the volume of each compression chamber 33b increases or decreases in accordance with the size of the space between the inner circumferential surface 33a of cylinder chamber 33 and the outer circumferential surface 23a of the rotor 23, both defining the compression chamber 33b. As the rotor 23 rotates, while the volume of the compression chamber 33b increases, refrigerant is sucked into the compression chamber 33b, and while the volume of the compression chamber 33b decreases, the refrigerant in the compression chamber 33b is compressed and discharged. In other words, of the entire stroke of the compression chamber 33b, in a range where the volume of the compression chamber 33b increases as the rotor 23 rotates, the compression chamber 33b is in a suction stroke, and in a range where the volume of the compression chamber 33b decreases as the rotor 23 rotates, the compression chamber 33b is in a compression stroke.

The cylinder block 29 includes an unillustrated suction port which sucks the refrigerant into the cylinder chamber 33, discharge ports 35 which discharge the refrigerant compressed in the cylinder chamber 33, on-off valves 37 which open or close the discharge ports 35, and a cylinder-side oil supply passage 41 communicating with oil supply passages of the side blocks 31a and 31b.

As illustrated in FIG. 1, the pair of side blocks 31a and 31b consists of a front side block 31a and a rear side block 31b. The oil separator 21 is attached to the rear side block 31b.

The front side block 31a includes a front-side end surface 43 in contact with the cylinder block 29, an unillustrated suction port communicating with the unillustrated suction port of the cylinder block 29 to suck the refrigerant from the suction chamber 11, a front-side bearing 47 rotatably supporting the drive shaft 27, and a front-side oil supply passage 49 communicating with the cylinder-side oil supply passage 41.

On the front-side end surface 43, two high-pressure supply grooves 53 are formed with intervals in the rotation direction X of the rotor 23, with which the oil O with a high pressure, which is a pressure of the discharged refrigerant (discharge pressure), is supplied into the back-pressure spaces 77 in the vane slots 75.

Formed in the front-side bearing 47 is a front-side annular groove 55 in an annular shape. The front-side annular groove 55 communicates with one end of the front-side oil supply passage 49. Note that the other end of the front-side oil supply passage 49 communicates with the cylinder-side oil supply passage 41. The front-side annular groove 55 also communicates with each of the high-pressure supply grooves 53 via an unillustrated passage formed in the front side block 31a.

The rear side block 31b includes a rear-side end surface 57 in contact with the cylinder block 29, two rear-side oil supply passages 59 and 59a, a rear-side bearing 63 rotatably supporting the drive shaft 27. The two rear-side oil supply passages 59 and 59a communicate with an oil supply hole for drawing the oil O reserved at a lower portion of the discharge chamber 15 and the cylinder-side oil supply passage 41.

As illustrated in FIG. 2, in the rear-side end surface 57, discharge holes 61 are formed for discharging the refrigerant having been compressed in the cylinder chamber 33. In addition, the rear-side end surface 57 has two high-pressure supply grooves 69 formed with intervals in the rotational direction X of the rotor 23, for supplying the oil O with a high pressure, which is a pressure of the discharged refrigerant (discharge pressure), to the back-pressure spaces 77 of the vane slots 75. Each high-pressure supply groove 69 communicates with a gap 67 between an end of the drive shaft 27 and the rear-side bearing 63 via a communication passage 65.

As illustrated in FIG. 1, a rear-side annular groove 73 in an annular shape is formed in the rear-side bearing 63. The rear-side annular groove 73 communicates with one end of one of the rear-side oil supply passages 59 and 59a. Note that the other end of the rear-side oil supply passage 59 communicates with the cylinder-side oil supply passage 41 via the rear-side oil supply passage 59a, which is the other one. The rear-side annular groove 73 communicates with the gap 67 via an unillustrated passage formed in the rear side block 31b.

As illustrated in FIG. 2, the back-pressure spaces 77 formed in the rotor 23 communicate with the high-pressure supply grooves 53 and 69 of the front side block 31a and the rear side block 31b after the compression chamber 33b between two vanes 25 moves into a suction stroke and until it moves out of a compression stroke.

As illustrated in FIG. 1, the oil separator 21 is attached to the rear side block 31b. The refrigerant compressed in the cylinder chamber 33 flows into the oil separator 21, where the refrigerant is separated into the refrigerant and the oil O by the centrifugal force while swirling and going down toward the bottom of the discharge chamber 15.

The drive shaft 27 is rotatably supported by the bearings 47 and 63 located at the side blocks 31a and 31b. Attached on one side of the drive shaft 27 is the rotor 23, and attached on the other side of the drive shaft 27 is the motor portion 4.

In the gas compressor 1 thus configured, when the drive shaft 27 is rotated by the motor portion 4, the rotor 23 attached on the drive shaft 27 rotates too.

Along with the rotation of the rotor 23, the refrigerant flows into the suction chamber 11 and is sucked from the suction chamber 11 via the suction port (not illustrated) of the front side block 31a into the cylinder chamber 33 (suction stroke). The refrigerant sucked into the cylinder chamber 33 is compressed in the compression chambers 33b formed by multiple vanes 25 in the cylinder chamber 33, by the volume of the compression chamber 33b being reduced along with the rotation of the rotor 23 (compression stroke).

The refrigerant compressed in the compression chambers 33b pushes and opens the on-off valves 37 and is discharged from the discharge ports 35 (discharge stroke), and then discharged from the discharge holes 61 via the oil separator 21 into the discharge chamber 15. The refrigerant discharged from the discharge holes 61 is separated into the refrigerant and the oil O by the oil separator 21. The refrigerant is discharged from the unillustrated discharge port to the unillustrated refrigeration cycle, and the oil O is reserved at the lower portion of the discharge chamber 15.

The oil O reserved at the lower portion of the discharge chamber 15 is supplied through the rear-side oil supply passage 59 of the rear side block 31b to the rear-side bearing 63.

The high-pressure oil O supplied to the rear-side bearing 63 is supplied through the gap 67 between the end of the drive shaft 27 and the rear-side bearing 63 and through the communication passage 65 to each high-pressure supply groove 69.

In addition, the high-pressure oil O is supplied from the rear-side oil supply passage 59a through the cylinder-side oil supply passage 41 and the front-side oil supply passage 49 to the front-side bearing 47.

The high-pressure oil O supplied to the front-side bearing 47 is supplied through the unillustrated passage to each high-pressure supply groove 53.

The high-pressure oil O supplied to each of the high-pressure supply grooves 53 and 69 of the front side block 31a and the rear side block 31b supplies high pressure to the back-pressure spaces 77 in the range from the suction stroke to the discharge stroke, and supplies the high pressure to the back surfaces of the vanes 25 to protrude the vanes 25 from the vane slots 75.

Meanwhile, since the cylinder chamber 33 is elliptical in a cross section perpendicular to the axial direction, the angle of the inner circumferential surface 33a at a portion, with which the distal end surface 25a of the vane 25 is in contact, with respect to the direction of protrusion and retraction of the vane 25 changes along with the rotation of the rotor 23. Accordingly, a position on the distal end surface 25a of the vane 25, which is in sliding contact with the inner circumferential surface 33a of the cylinder chamber 33, also changes along with the rotation of the rotor 23.

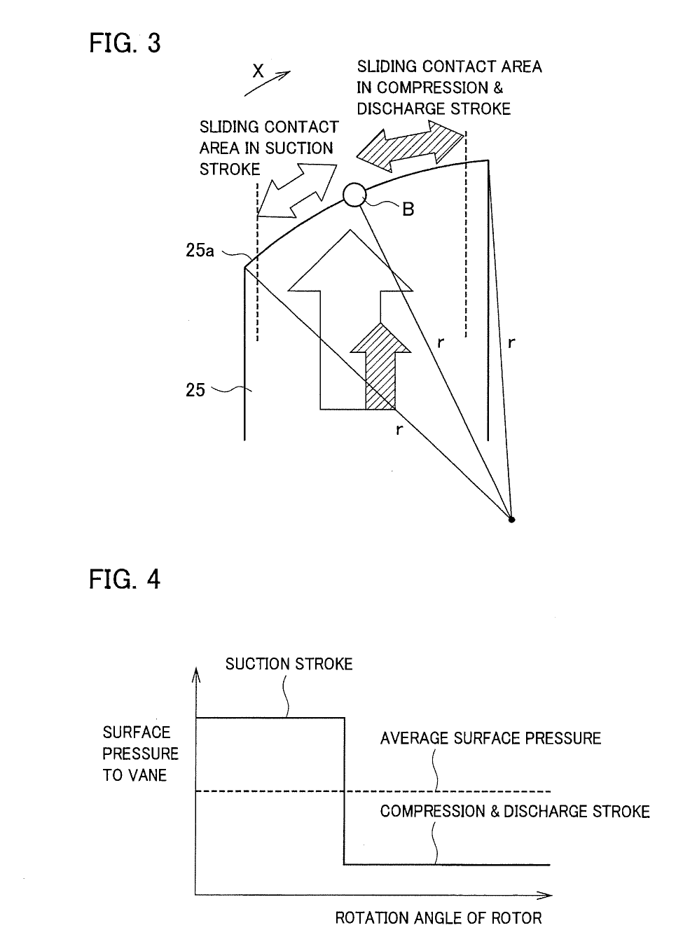

For this reason, the distal end surface 25a of the vane 25 is formed to be a circular arc surface with a curvature larger than the maximum curvature of the inner circumferential surface 33a of the cylinder chamber 33. FIG. 3 is an enlarged view of the distal end portion of the vane 25 in the case where the distal end surface 25a of the vane 25 is formed to be a circular arc surface with a single radius of curvature r.

Here, the distal end surface 25a of the vane 25 functions as a pressure receiving surface receiving the pressure of the refrigerant in the compression chamber 33b. The pressure that the vane 25 receives from the refrigerant in the compression chamber 33b through the distal end surface 25a serves as a force in the direction of retracting the vane 25 into the vane slot 75. This force serves as a counter force against that force in the direction of protruding the vane 25 from the vane slot 75, which the vane 25 receives from the high-pressure oil O introduced into the back-pressure space 77 in the vane slot 75.

This counter force is small in the suction stroke where the refrigerant is sucked into the compression chamber 33b because the pressure that the vane 25 receives from the refrigerant in the compression chamber 33b is low. On the other hand, the counter force is large in the compression stroke and the discharge stroke where the refrigerant in the compression chamber 33b is compressed and discharged because the pressure that the vane 25 receives from the refrigerant in the compression chamber 33b is high.

From this reason, as for the force in the protruding direction substantially exerted on the vane 25 with the counter force described above subtracted, the force in the suction stroke indicated by the hollow upward arrow in FIG. 3 is larger than the force in the compression stroke and the discharge stroke indicated by the hatched upward arrow in FIG. 3.

Hence, when the compression chamber 33b is in the suction stroke and the counter force exerted by the refrigerant in the compression chamber 33b on the distal end surface 25a of the vane 25 is small, the force biasing the vane 25 in the protruding direction exerted by the high-pressure oil O in the back-pressure space 77 is at an excessive degree.

As a result, as illustrated in FIG. 4, when the compression chamber 33b is in the suction stroke, the surface pressure of the distal end surface 25a of the vane 25 is higher than when the compression chamber 33b is in the compression stroke or the discharge stroke. Accordingly, the average surface pressure of the entire stroke is also high. Hence, the sliding resistance of the vane 25 to the inner circumferential surface 33a of the cylinder chamber 33 is high and the motor portion 4 requires a large torque to rotate the rotor 23.

In this respect, it is desirable to decrease the surface pressure of the distal end surface 25a of the vane 25 when the compression chamber 33b is in the suction stroke.

Meanwhile, for the example of the vane 25 illustrated in FIG. 3, when the compression chamber 33b is in the suction stroke, the upstream area of the distal end surface 25a in the rotational direction X of the rotor 23, which is on the left side of the boundary B in FIG. 3, is in sliding contact with the inner circumferential surface 33a of the cylinder chamber 33. This is because, when the compression chamber 33b is in the suction stroke of the inner circumferential surface 33a of the cylinder chamber 33, the inclination angle of the portion in sliding contact with the distal end surface 25a of the vane 25 with respect to the direction of protrusion and retraction of the vane 25 is small.

On the other hand, when the compression chamber 33b is in the compression stroke or the discharge stroke, the downstream area of the distal end surface 25a in the rotational direction X of the rotor 23, which is on the right side of the boundary B in FIG. 3, is in sliding contact with the inner circumferential surface 33a of the cylinder chamber 33. This is because, when the compression chamber 33b is in the compression stroke or in the discharge stroke of the inner circumferential surface 33a of the cylinder chamber 33, the inclination angle of the portion in sliding contact with the distal end surface 25a of the vane 25 with respect to the direction of protrusion and retraction of the vane 25 is large.

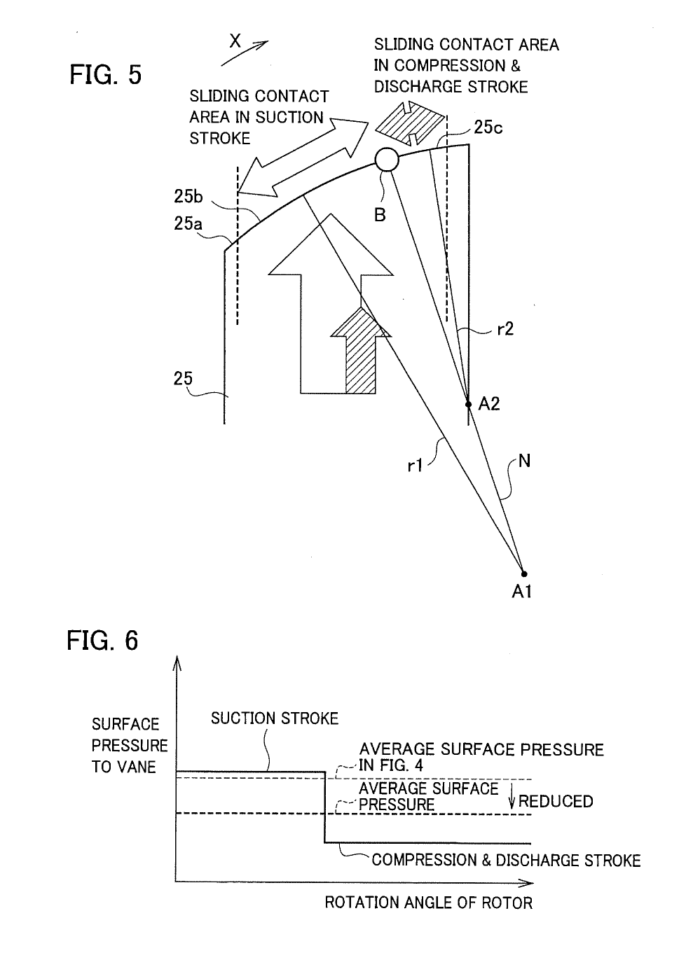

In this embodiment, as illustrated in FIG. 5, the distal end surface 25a of the vane 25 is formed by connecting at the boundary B a suction-side area 25b upstream (on the left side in FIG. 5) of the boundary B (connection point) in the rotational direction X and a compression-side area 25c downstream (on the right side in FIG. 5) of the boundary B in the rotational direction X. The radius of curvature r1 of the suction-side area 25b is larger than the radius of curvature r2 of the compression-side area 25c. In addition, the radii of curvature r1 and r2 are smaller than the minimum radius of curvature of the inner circumferential surface 33a. Note that as illustrated in FIG. 5, it is preferable that the suction-side area 25b be formed to have a single radius of curvature r1 from the viewpoint of manufacturability. Similarly, it is preferable that the compression-side area 25c be formed to have a single radius of curvature r2.

The suction-side area 25b is an area that is in sliding contact with the inner circumferential surface 33a of the cylinder chamber 33 when the compression chamber 33b is in the suction stroke, and the compression-side area 25c is an area that is in sliding contact with the inner circumferential surface 33a of the cylinder chamber 33 when the compression chamber 33b is in the compression stroke or the discharge stroke.

Both of the center of curvature A1 of the suction-side area 25b and the center of curvature A2 of the compression-side area 25c are arranged on the normal line N to the suction-side area 25b and the compression-side area 25c, which passes through the boundary B. In other words, in a cross section perpendicular to the axial direction of the rotor 23, the boundary B and the centers of curvature A1 and A2 are arranged on the same straight line. This allows the suction-side area 25b and the compression-side area 25c to be connected at the boundary B continuously and smoothly, and prevents a step in a direction perpendicular to the rotational direction X (radial direction of the rotor 23) from occurring on the distal end surface 25a.

Since the radius of curvature r1 of the suction-side area 25b is designed to be larger than the radius of curvature r2 of the compression-side area 25c, the surface pressure, obtained by Hertz contact stress, of the distal end surface 25a of the vane 25 when the distal end surface 25a of the vane 25 slides on the inner circumferential surface 33a of the cylinder chamber 33 is relatively smaller in the suction-side area 25b than in the compression-side area 25c. Hence, the actual friction coefficient when the suction-side area 25b of the distal end surface 25a of the vane 25 slides on the inner circumferential surface 33a of the cylinder chamber 33 is smaller than the actual friction coefficient when the compression-side area 25c slides.

Therefore, even though, when the compression chamber 33b is in the suction stroke where the counter force in the retraction direction into the vane slot 75, which is exerted by the refrigerant in the compression chamber 33b on the distal end surface 25a of the vane 25, is smaller than when the compression chamber 33b is in the compression stroke or the discharge stroke, the vane 25 is biased in the direction of the vane 25 protruding from the vane slot 75 by the same magnitude as it is biased when the compression chamber 33b is in the compression stroke, the sliding resistance of the distal end surface 25a of the vane 25 on the inner circumferential surface 33a of the cylinder chamber 33 can be suppressed at a low level.

As illustrated in the graph of FIG. 6, this makes it possible to reduce the surface pressure of the distal end surface 25a of the vane 25 when the compression chamber 33b is in the suction stroke, and thereby also reducing the average surface pressure of the entire stroke. As a result, this makes it possible to reduce the sliding resistance of the vane 25 on the inner circumferential surface 33a of the cylinder chamber 33, and to reduce the torque required for the motor portion 4 to rotate the rotor 23.

Note that in the case the suction-side area 25b of the distal end surface 25a of the vane 25 is formed with a large radius of curvature r1, the dimension of the suction-side area 25b in the rotational direction X of the rotor 23 needs to be large compared to the case where the suction-side area 25b is formed with a smaller radius of curvature than in the above case.

For this reason, in this embodiment, the compression-side area 25c is formed with a small radius of curvature r2 to make small the dimension of the compression-side area 25c in the rotational direction X of the rotor 23 compared to the case where the compression-side area 25c is formed with a larger radius of curvature than in this case.

This makes it possible to arrange the boundary B between the suction-side area 25b and the compression-side area 25c to be downstream of the middle position in the rotational direction X of the rotor 23 to form the vane 25 such that the total dimension of the vane 25 in the rotational direction X will not be changed, even though the suction-side area 25b is formed with a large radius of curvature r1.

In this case, since the compression-side area 25c is formed with a small radius of curvature r2, the surface pressure of the distal end surface 25a of the vane 25 is high when the compression chamber 33b is in the compression stroke or the discharge stroke, compared to the case where the compression-side area 25c is formed with a larger radius of curvature than in this case.

However, when the compression chamber 33b is in the compression stroke or the discharge stroke, the counter force that the vane 25 receives from the refrigerant in the compression chamber 33b is high because of the compression of the refrigerant. Thus, since the force actually exerted on the vane 25 in the protruding direction with the counter force subtracted is small, the surface pressure of the distal end surface 25a of the vane 25 is originally small. Therefore, the increase of the surface pressure by forming the compression-side area 25c with a small radius of curvature r2 is not so large and does not largely increase the average surface pressure.

Although an embodiment of the present invention has been described above, the embodiment is a mere example described to facilitate understanding of the present invention, and the present invention is not limited to this embodiment. The technical scope of the present invention is not limited to the specific technical matters disclosed in the above embodiment, but includes various modifications, changes, alternative techniques, and the like that can be easily derived therefrom.

For example, the above embodiment has presented an example where the present invention is applied to an electric gas compressor 1 in which the rotor 23 of the compression portion 3 is rotated by the motor portion 4. However, the present invention is widely applicable to rotary vane gas compressors other than electric ones, such as, for example, a rotary vane gas compressor and the like that are mounted on a vehicle and in which the rotor is rotated by the power of the engine.

In addition, applications for the present invention are not limited to rotary vane gas compressors in which a cross-sectional shape perpendicular to the axial direction of the cylinder chamber is elliptical as described in the embodiment. For example, the present invention is also applicable to rotary vane gas compressors in which the cylinder chamber has a shape other than a precise circle and vane rotary gas compressors in which the rotation center of the rotor is decentered from the center of the cylinder chamber.

This application claims priority based on Japanese Patent Application No. 2015-025286 filed on Feb. 12, 2015, the entire contents of which are incorporated herein by reference.

### INDUSTRIAL APPLICABILITY

The present invention can be utilized in what is called a vane rotary gas compressor.

### REFERENCE SIGNS LIST

1 gas compressor
2 housing
3 compression portion
4 motor portion
7 front head
9 rear case
11 suction chamber
13 inner wall
15 discharge chamber
19 compression block
21 oil separator
23 rotor
23a outer circumferential surface
25 vane
25a distal end surface
25b suction-side area
25c compression-side area
27 drive shaft
29 cylinder block
31a front side block
31b rear side block
33 cylinder chamber
33a inner circumferential surface
33b compression chamber
35 discharge port
37 on-off valve
41 cylinder-side oil supply passage
43 front-side end surface
47 front-side bearing
49 front-side oil supply passage
53, 69 high-pressure supply groove
55 front-side annular groove
57 rear-side end surface
59 rear-side oil supply passage
59a rear-side oil supply passage
61 discharge hole
63 rear-side bearing
65 communication passage
67 gap
73 rear-side annular groove
75 vane slot
77 back-pressure space
A1, A2 center of curvature
B boundary (connection point)
N normal line
O oil
X rotational direction
r, r1, r2 radius of curvature

1. A gas compressor comprising:
a cylinder block in a cylindrical shape, having a cylinder chamber where to compress refrigerant;
a rotor rotatably provided in the cylinder chamber, the rotor having an outer circumferential surface facing an inner circumferential surface of the cylinder chamber and a plurality of vane slots opening on the outer circumferential surface with intervals in a rotational direction of the rotor; and
a plurality of vanes housed in the respective vane slots and biased in a direction of protruding from the outer circumferential surface, distal end surfaces of the vanes sliding on the inner circumferential surface along with rotation of the rotor, the vanes partitioning a space between the outer circumferential surface and the inner circumferential surface into a plurality of compression chambers in which the refrigerant is sucked and compressed, wherein
the distal end surface of each of the vanes has a suction-side area that is in sliding contact with the inner circumferential surface when the compression chamber separated by the vane having the distal end surface is in a suction stroke, and a compression-side area that is in sliding contact with the inner circumferential surface when the compression chamber separated by the vane having the distal end surface is in a compression stroke,
the suction-side area and the compression-side area have smaller radii of curvature than that of the inner circumferential surface, and
the suction-side area has a larger radius of curvature than that of the compression-side area.

2. The gas compressor according to claim 1, wherein
the compression-side area has a single radius of curvature.

3. The gas compressor according to claim 1, wherein
an upstream portion and a downstream portion of the distal end surface in the rotational direction of the rotor constitute the suction-side area and the compression-side area, respectively.

4. The gas compressor according to claim 1, wherein
a center of curvature of the suction-side area and a center of curvature of the compression-side area are arranged on a normal line to the distal end surface at a connection point between the suction-side area and the compression-side area.

5. The gas compressor according to claim 1, wherein
the connection point between the suction-side area and the compression-side area is arranged downstream of a middle point of the distal end surface in the rotational direction.
